(19) United States
(12) Patent Application Publication
(10) Pub. No.: US 2022/0082002 A1
(43) Pub. Date: Mar. 17, 2022

(54) HEATING TO INDUCE STRONG POLYMER GEL FOR CONFORMANCE IMPROVEMENT

(71) Applicant: SAUDI ARABIAN OIL COMPANY, Dhahran (SA)

(72) Inventors: Jinxun Wang, Dhahran (SA); Abdulkareem M. Al-Sofi, Dhahran (SA); Amer M. Anazi, Dammam (SA)

(73) Assignee: SAUDI ARABIAN OIL COMPANY, Dhahran (SA)

(21) Appl. No.: 17/022,554

(22) Filed: Sep. 16, 2020

(51) Int. Cl. E21B 43/24; C09K 8/588

(52) U.S. Cl. CPC E21B 43/24; C09K 8/588

(57) ABSTRACT

Methods for treating a hydrocarbon-containing formation may include preheating a gelant that contains a crosslinkable polymer, one or more crosslinking agents, and an aqueous fluid; and injecting the gelant into the formation, wherein the gelant forms a gel in the formation. Methods for enhanced oil recovery may include preheating a gelant that contains a crosslinkable polymer, one or more crosslinking agents, and an aqueous fluid; injecting the gelant into a high permeability zone of a hydrocarbon-containing formation, wherein the gelant forms a gel; and stimulating a flow of hydrocarbons from a low permeability zone of the hydrocarbon-containing formation.

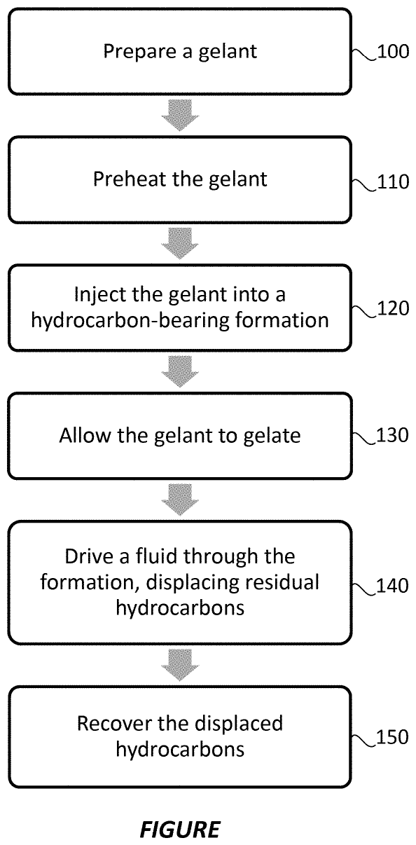

Enhanced oil recovery (EOR) enables the extraction of hydrocarbon reserves that are otherwise inaccessible. Chemical injection (or chemical flooding) is one of the most widely used EOR techniques as application of various chemical reagents can greatly improve oil recovery by, for example, improving the mobility and/or reducing the surface tension of the hydrocarbon reserves.

Hydrocarbon-containing formations that have variable permeabilities can be challenging to access by EOR methods. The injected fluids will be preferentially channeled to high permeability intervals, leaving the less permeable intervals unswept and, consequently, not recovering a portion of the reserve. To improve oil recovery by chemical injection, the injection profile of the reservoir well may be modified.

Conformance improvement technologies may be utilized to overcome the difficulties posed by variable permeability reservoirs by enhancing the uniformity of a reservoir and improving sweep efficiency. The use of polymer gels (or polymer waterflooding) is one of the most promising conforming improvement techniques. In flow diverting applications, a polymer gel may be placed in the high permeability intervals, diverting the subsequent injected water to the lower permeability zones. In water shutoff applications, a gelant may be injected through production wells to block or reduce any unwanted excess water and/or gas production. Generally, a crosslinker-containing polymer solution (gelant) is injected into the formation and, after a certain time (known as the gelation time), gelation occurs in the formation. It can be challenging to place the gel in deep highly permeable zones, or to improve the conformance of extremely heterogeneous reservoirs, as a longer gelation time is required for deep gel placement and a strong gel is needed to efficiently block the highly permeable strata.

### SUMMARY OF INVENTION

In one aspect, embodiments disclosed herein are directed to methods for treating a hydrocarbon-containing formation. The methods may include preheating a gelant that contains a crosslinkable polymer, one or more crosslinking agents, and an aqueous fluid. The method may further include injecting the gelant into the formation, wherein the gelant forms a gel in the formation.

In another aspect, embodiments disclosed herein are directed to methods for enhanced oil recovery. The methods may include preheating a gelant that contains a crosslinkable polymer, one or more crosslinking agents, and an aqueous fluid. The method may further include injecting the gelant into a high permeability zone of a hydrocarbon-containing formation, wherein the gelant forms a gel. Further, following formation of a gel, the method may include stimulating a flow of hydrocarbons from a low permeability zone of the hydrocarbon-containing formation.

Other aspects and advantages of the invention will be apparent from the following description and the appended claims.

### BRIEF DESCRIPTION OF THE DRAWING

The FIGURE is a flowchart depicting a method of treating a hydrocarbon-bearing formation in accordance with one or more embodiments of the present disclosure.

### DETAILED DESCRIPTION

One or more embodiments of the present disclosure relate to methods of generating polymer gels in a hydrocarbon-containing subterranean formation. These methods may provide conformance improvement, where the generation of the gel modifies the injection profile of the formation by diverting injection fluids to lower permeability zones of the reservoir. One or more embodiments of the present disclosure relate to methods of generating said gels in EOR processes.

The successful application of polymer gels to improve the conformance of a formation requires the injectant to possess sufficient injectivity (flowability) and, upon gelation, yield a gel of requisite strength. Having a high flowability allows the solution to efficaciously access the target treatment region, while a specific gel strength is necessary to ensure the effectiveness of the resulting gel for fluid diverting or blocking.

As noted previously, a longer gelation time is required for deep gel placement. A technique for elongating the gelation time is to use chemical retardation agents, such as water-soluble carboxylate anions, like, for example, acetate, lactate, malonate and glycolate. However, these retardation agents generally result in a gel that possesses a decreased gel strength. Using higher concentrations of polymer and/or crosslinker may improve the gel strength in such cases, but this in turn shortens the gelation time and increases the cost of the treatment.

In contrast, one or more embodiments of the present disclosure advantageously provide novel methods that yield a strong gel, while maintaining higher flowability for a longer time (i.e. delay gelation). One or more embodiments achieve this by preheating the gelant at temperatures higher than reservoir conditions prior to its injection.

Gelants of one or more embodiments may employ one or more crosslinkable polymers, one or more crosslinking agents, and an aqueous fluid. The gelants may uniquely exhibit delayed gelation while also providing a high gel strength. In some embodiments, the gelants may consist essentially of the crosslinkable polymers, the crosslinking agents, and the aqueous fluid. In particular embodiments, the gelants may consist of the crosslinkable polymers, the crosslinking agents, and the aqueous fluid.

The crosslinkable polymer of one or more embodiments is not particularly limited, and may be any suitable water-soluble crosslinkable polymer known to a person of ordinary skill in the art. The crosslinkable polymer of one or more embodiments may be a synthetic polymer or a biopolymer. The crosslinkable polymer can be a homopolymer or a copolymer. The crosslinkable polymer can be linear or branched. A person of ordinary skill in the art will, with the benefit of this disclosure, appreciate that the choice of crosslinkable polymer will influence the properties of the resulting gel.

In one or more embodiments, the crosslinkable polymer may be derived from monomers selected from the group consisting of acrylamides, acrylates, acetamides, formamides, saccharides, and derivatives thereof. In one or more embodiments, the crosslinkable polymer may be, for example, one or more of the group consisting of a polyacrylamide, copolymers of acylamide and acrylate, copolymers of acrylamide tertiary butyl sulfonate (ATBS) and acrylamides, and copolymers of acrylamide, acrylic acid and ATBS, carboxymethyl cellulose (CMC), carboxymethylhydroxyethyl cellulose (CMHEC), and xanthan gum.

The crosslinkable polymer of one or more embodiments may be functionalized to modify its properties. For instance, in some embodiments, the crosslinkable polymer may be sulfonated, esterified, amidated, or the like.

In particular embodiments, the crosslinkable polymer may be a sulfonated crosslinkable polymer and may have a sulfonation degree of the range of 10 to 90%. For example, the sulfonated crosslinkable polymer may have a sulfonation degree that is of an amount of a range having a lower limit of any of 10, 15, 20, and 25% and an upper limit of any of 70, 80, and 90%, where any lower limit can be used in combination with any mathematically-compatible upper limit.

In one or more embodiments, the crosslinkable polymer may have a molecular weight of the range of about one million Daltons (Da) to 30 million Da. For example, the crosslinkable polymer may have a molecular weight that is of a range having a lower limit of any of 3 to 5, 4 to 6, 5 to 8 million Da and an upper limit of any of 10 to 12, 12 to 14, 14 to 15, 18, or 30 million Da, where any lower limit can be used in combination with any mathematically-compatible upper limit.

In one or more embodiments, the crosslinkable polymer may have a degree of polymerization of the range of about 10,000 to about 500,000. For example, the polymeric component may have a degree of polymerization that is of a range having a lower limit of any of 10,000, 12,000, 15,000, 20,000, 25,000, 50,000, and 100,000 and an upper limit of any of 50,000, 100,000, 150,000, 200,000, 300,000, 400,000, and 500,000, where any lower limit can be used in combination with any mathematically-compatible upper limit.

The gelant of one or more embodiments may comprise the crosslinkable polymer in a lower amount than is typically used in such solutions. For example, in one or more embodiments, the gelant may comprise the crosslinkable polymer in an amount of 10,000 parts per million by weight (ppmw) or less, 7,500 ppmw or less, or 5,000 ppmw or less. In some embodiments, the gelant may comprise the crosslinkable polymer in an amount of the range of about 500 to 50,000 ppmw. For example, the gelant may contain the crosslinkable polymer in an amount of a range having a lower limit of any of 500, 1,000, 2,000, 3,000, and 5,000 ppmw and an upper limit of any of 3,000, 4,000, 5,000, 10,000, 20,000, 30,000, 40,000, and 50,000 ppmw, where any lower limit can be used in combination with any mathematically-compatible upper limit.

In one or more embodiments, the crosslinkable polymer may have a density that is greater than 1.00 grams per cubic centimeter (g/cm³). For example, the crosslinkable polymer may have a density that is of an amount of a range having a lower limit of any of 1.00, 1.10, 1.20, 1.30, 1.40, and 1.50 g/cm³ and an upper limit of any of 1.40, 1.50, 1,60, 1.70, 1.80, and 2.00 g/cm³, where any lower limit can be used in combination with any mathematically-compatible upper limit.

The crosslinking agent of one or more embodiments is not particularly limited, and may be any suitable crosslinking agent known to a person of ordinary skill in the art. The crosslinking agent of one or more embodiments may be an organic crosslinking agent or an inorganic crosslinking agent. The organic crosslinking agent of one or more embodiments may be selected from the group consisting of hydroquinone (HQ), hexamethylenetetramine (HMTA), phenol, formaldehyde, resorcinol, terephthalaldehyde, and the like. The inorganic crosslinking agent of one or more embodiments may be a multivalent cation and may be selected from the group consisting of Cr(III), Al(III), Ti(III), Zr(IV), and the like.

The gelant may contain one or more crosslinking agents, two or more crosslinking agents, or three or more crosslinking agents. The gelant of one or more embodiments may comprise the crosslinking agents in a lower amount than is typically used in such solutions. For example, in one or more embodiments, the gelant may contain the crosslinking agents in a total amount of 10,000 ppmw or less, 7,500 ppmw or less, 5,000 ppmw or less, 3,000 ppmw or less, or 1,500 ppmw or less. In some embodiments, the gelant may comprise the crosslinking agents in a total amount of the range of about 1 to 10,000 ppmw. For example, the gelant may contain the crosslinking agents in a total amount of a range having a lower limit of any of 1, 100, 200, 500, 1,000, 1,500, 2,000, 3,000, and 5,000 ppmw and an upper limit of any of 1,500, 2,000, 2,500, 3,000, 4000, 5,000, 7,500, and 10,000 ppmw, where any lower limit can be used in combination with any mathematically-compatible upper limit.

In embodiments where the gelant contains two or more crosslinking agents, the gelant may comprise a first crosslinking agent and a second crosslinking agent. In some embodiments, the gelant may include an excess, by weight, of one of the first and second crosslinking agents, relative to the other. In particular embodiments, there may be a weight excess of the first crosslinking agent to the second crosslinking agent. For example, the weight ratio of the first crosslinking agent to the second crosslinking agent used in the methods of the present disclosure may be of the range of 1:1 to 5:1. In some vembodiments, the first and second crosslinking agents may be used in amounts such that the weight ratio of the first crosslinking agent to the second crosslinking agent is of a range having a lower limit of any of 1:1, 1.5:1, and 2:1 and an upper limit of any of 2:1,2.5:1, 3:1, 4:1, and 5:1, where any lower limit can be used in combination with any mathematically-compatible upper limit.

In one or more embodiments, the gelant may contain the first crosslinking agent in an amount of the range of about 500 to 10,000 ppmw. For example, the gelant may contain the first crosslinking agent in an amount of a range having a lower limit of any of 500, 750, 1,000, 1,500, 2,000, 3,000, and 5,000 ppmw and an upper limit of any of 1,000, 1,500, 2,000, 2,500, 5,000, 7,500, and 10,000 ppmw, where any lower limit can be used in combination with any mathematically-compatible upper limit. The gelant may comprise a second crosslinking agent in an amount of the range of about 100 to 2,000 ppmw. For example, the gelant may contain the second crosslinking agent in an amount of a range having a lower limit of any of 100, 250, 500, 750, and 1,000 ppmw and an upper limit of any of 500, 750, 1,000, 1,350, 1,500, 1,750, and 2,000 ppmw, where any lower limit can be used in combination with any mathematically-compatible upper limit.

Gelants of one or more embodiments may comprise an aqueous fluid. The aqueous fluid may include at least one of natural and synthetic water, fresh water, seawater, brine, brackish, formation, production water, and mixtures thereof. The aqueous fluid may be fresh water that is formulated to contain various salts. The salts may include, but are not limited to, alkali metal and alkaline earth metal halides, hydroxides, carbonates, bicarbonates, sulfates, and phosphates. In one or more embodiments of the treatment fluid disclosed, the brine may be any of seawater, aqueous solutions where the salt concentration is less than that of seawater, or aqueous solutions where the salt concentration is greater than that of seawater. Salts that may be found in brine may include salts that produce disassociated ions of sodium, calcium, aluminum, magnesium, potassium, strontium, lithium, halides, carbonates, bicarbonates, sulfates, chlorates, bromates, nitrates, oxides, and phosphates, among others. In some embodiments, the brine may include one or more of the group consisting of an alkali metal halide, an alkali metal sulfate salt, an alkaline earth metal halide, and an alkali metal bicarbonate salt. In particular embodiments, the brine may comprise one or more of the group consisting of sodium chloride, calcium chloride, magnesium chloride, sodium sulfate, and sodium bicarbonate. Any of the aforementioned salts may be included in brine.

The aqueous fluid of one or more embodiments may have a total dissolved solids (TDS) of 1,000 milligrams per liter (mg/L) or more, 10,000 mg/L or more, 50,000 mg/L or more, or 100,000 mg/L or more. In some embodiments, the aqueous fluid may have a TDS of an amount of a range having a lower limit of any of 1,000, 5,000, 10,000, 30,000, 50,000, and 55,000 mg/L and an upper limit of any of 50,000, 55,000, 60,000, 65,000, 75,000, 100,000, 150,000, 200,000, 250,000, and 350,000 mg/L, where any lower limit can be used in combination with any mathematically-compatible upper limit. A person of ordinary skill in the art would appreciate with the benefit of this disclosure that the density of aqueous fluid, and, in turn, the treatment fluid, may be effected by the salt concentration of the aqueous fluid. The maximum concentration of a given salt is determined by its solubility.

The gelants of one or more embodiments may include one or more additives. The additives may be any conventionally known and one of ordinary skill in the art will, with the benefit of this disclosure, appreciate that the selection of said additives will be dependent upon the intended application of the treatment fluid. In some embodiments, the additives may be one or more selected from clay stabilizers, scale inhibitors, corrosion inhibitors, biocides, friction reducers, thickeners, and the like.

The gelant of one or more embodiments may comprise the one or more additives in a total amount of the range of about 0.01 to 15.0 wt. %. For example, the fluid may contain the additives in an amount of a range having a lower limit of any of 0.01, 0.05, 0.1, 0.5, 1.0, 2.5, 5.0, 1.5, 10.0 and 12.5 wt. % and an upper limit of any of 0.1, 0.5, 1.0, 2.5, 5.0, 7.5, 10.0, 12.5, and 15.0 wt. %, where any lower limit can be used in combination with any mathematically-compatible upper limit.

As discussed previously, additives such as chemical retardation agents are known to provide an elongated gelation time. However, gelants in accordance with one or more embodiments the present disclosure may be free of a retarder. In one or more embodiments, the gelant may exhibit a sufficiently long gelation time without the inclusion of such a retarder, and the resulting gel may be stronger than would be obtained in the presence of a retarder.

In other embodiments, in order to further elongate the gelation time, the gelant may include a retarder. For example, the retarder may be one or more alkali metal salts, such as sodium lactate, sodium acetate, sodium malonate, or sodium glycolate, or other known retarding agents. Increasing the concentration of retarder will elongate the gelation time but also decrease the strength of the resulting gel. Therefore, in order to retain a strength of the resulting gel when using a retarder, one or more embodiments may utilize a higher concentration of the crosslinkable polymer and a higher concentration of the crosslinking agents, as compared to embodiments where a retarder is not used. In some embodiments, however, it may be acceptable to trade off the gel strength for longer gelation time.

In one or more embodiments, the gelant may comprise a retarder in an amount of 0.5 wt. % or less, 0.3 wt. % or less, 0.2 wt. % or less, or 0.1 wt. % or less. In some embodiments, the gelant may comprise the retarder in an amount of 0.01 wt. % or less.

In one or more embodiments, the gelant may contain little to no solid material.

For example, the gelants of some embodiments may contain solid material in an amount of 2 wt. % or less, 1 wt. % or less, 0.5 wt. % or less, 0.1 wt. % or less, 0.05 wt. % or less, 0.01 wt. % or less, or 0.001 wt. % or less.

Methods in accordance with one or more embodiments of the present disclosure may comprise the injection of a previously discussed gelant into a hydrocarbon-containing formation. In one or more embodiments, the gelant may be the only treatment fluid and the method may comprise only one pumping stage. In other embodiments, methods in accordance with one or more embodiments may involve the injection of the gelant and one or more additional stimulation fluids. The additional stimulation fluids may, in some embodiments, be co-injected with the gelant. In some embodiments, the stimulation fluids may be injected after the gelant.

The gelant of one or more embodiments may have a low viscosity at reservoir temperatures and, therefore, good injectivity, while being thermally stable enough for use downhole. After certain time at reservoirconditions, the gelant may gelate, resulting in an increase in viscosity. This phenomenon has the effect of reducing fluid mobility, resulting in diverting the flow from high permeability zones to lower ones and, ultimately, providing improved oil recovery.

The methods of one or more embodiments of the present disclosure may further comprise a preheating step before the injection of the gelant. The preheating step may comprise heating the gelant to a temperature above that of the formation. The preheating step of one or more embodiments may allow the production of a stronger gel than would be provided in the absence of said preheating.

The hydrocarbon-containing formation of one or more embodiments may be a formation containing multiple zones of varying permeability. For instance, the formation may contain at least a zone having a relatively higher permeability and a zone having a relatively lower permeability. During conventional injection, fluids preferentially sweep the higher permeability zone, leaving the lower permeability zone incompletely swept. In one or more embodiments, the increased viscosity of the gelant may “plug” the higher permeability zone, allowing subsequent fluid to sweep the low permeability zone and improving sweep efficiency.

In one or more embodiments, the formation may have a temperature of the range of about 15 to 250° C. For example, the formation may have a temperature that is of an amount of a range having a lower limit of any of 15, 20, 25, 40, 50 60, 70, and 80° C. and an upper limit of any of 80, 90, 100, 120, 140, 160, 180, 200, 225, and 250° C., where any lower limit can be used in combination with any mathematically-compatible upper limit.

In one or more embodiments, the preheating may be performed at a temperature of the range of about 30 to 280° C. For example, the preheating may be performed at a temperature of a range having a lower limit of any of 30, 50, 70, 90, and 100° C. and an upper limit of any of 100, 120, 140, 160, 180, 200, 225, 250, and 280° C., where any lower limit can be used in combination with any mathematically-compatible upper limit.

In one or more embodiments, the preheating may be performed at a temperature that is greater than that of the formation by an amount of the range of 10 to 100° C. For example, the preheating may be performed at a temperature that is greater than that of the formation by an amount of a range having a lower limit of any of 10, 20, 30, 40, and 50° C. and an upper limit of any of 30, 40, 50, 60, 70, 80, 90, and 100° C., where any lower limit can be used in combination with any mathematically-compatible upper limit.

In one or more embodiments, the preheating may be performed for a duration of about 1 h or more, 2 h or more, or 3 h or more. For example, the preheating may be performed for a duration of a range having a lower limit of any of 1, 1.5, 2, 2.5, 3, 4, and 5 h and an upper limit of any of 3, 4, 5, 6, 10, 12, 18, and 24 h, where any lower limit can be used in combination with any mathematically-compatible upper limit.

The methods of one or more embodiments may be used for EOR or well stimulation. An EOR process in accordance with one or more embodiments of the present disclosure is depicted by, and discussed with reference to, the Figure.

Specifically, in step 100, any of the previously discussed gelants may be prepared. The method of preparing the fluid of one or more embodiments is not particularly limited and may involve combining the components of the gelant in any suitable order and/or amounts to yield the desired gelant. In step 110, the gelant may be preheated as described previously. In step 120, the gelant may be injected into a hydrocarbon-bearing formation at an injection well. In some embodiments, the injection of the gelant may be performed at a pressure that is below the fracturing pressure of the formation. In step 130, after the gelation time, the gelant may gelate in the formation. In particular embodiments, the gelation may be performed in the highly permeable zones of the formation. In step 140, after the gelation of the gelant, a fluid may be diverted to the lower-permeability zones of the formation, displacing hydrocarbons. As a result, the gel may “plug” the more permeable zones of the formation. The fluid that displaces the hydrocarbons may be the tail-end of the gelant or may be a different fluid. In step 150, the displaced hydrocarbons may be recovered from the formation. In one or more embodiments, the hydrocarbons may be recovered at a production well.

In one or more embodiments, the EOR process may be repeated one or more times to increase the amount of hydrocarbons recovered. In some embodiments, subsequent well stimulation processes may involve the use of different amounts of the surfactant and/or different surfactants than the first. The methods of one or more embodiments may advantageously provide improved sweep efficiency.

EOR, which may be called tertiary recovery, may include any oil recovery enhancement methods. EOR may include oil recovery methods after conventional methods (for example, primary and secondary). The primary recovery may include natural flow and artificial lift, while the secondary recovery may include pressure maintenance techniques (mainly refers to waterflooding). EOR techniques may be initiated at any stage of oil production and may improve sweep efficiency and oil displacement efficiency. EOR operations may include chemical flooding (alkaline flooding, surfactant flooding and polymer flooding, or any combinations of them), miscible displacement (carbon dioxide (CO₂) injection or hydrocarbon injection), and thermal recovery (steam flooding or in-situ combustion). The use of gels for conformance control, especially if at low volumes (near wellbore treatments), may be classified under Improved Oil Recovery (IOR). IOR refers to a broader set of technologies that increase recovery beyond that of conventional floods and include, beside EOR, infill drilling, well optimization, rates allocation, etc.

The gelants of one or more embodiments may gelate after the gelation time of the fluid. The gelation rate and gel strength of a gelant may be evaluated by observing the flowability variation of the fluid with time at a specific temperature. A commonly used observation criterion for determining these properties was proposed by Sydansk, R. D., 1990. A newly developed chromium (III) gel technology, SPE Reservoir Engineering, 5(3), 346-352 (“Sydansk”), using a code system that ranges from A to J to describe ten different levels of gel strength based on visual observation. The gel strength sequentially increases from codes A to J, with code A representing no gel formed, B to D representing a weak gel, with B being slightly more viscous than the (initial) polymer solution, C showing a detectable gel with high flow ability, and D representing moderately flowing gel. Codes after E are classified as strong gels. E represents a barely flowing gel, F is a highly deformable non-flowing gel, and G is moderately deformable non-flowing gel. H represents a slightly deformable non-flowing gel, while I and J are very strong gels, which exhibit no gel-surface deformation when a sample bottle is inverted.

Both gelation rate and gelation time can be used to characterize how fast the gel is formed. Sydansk (1990) mainly used the gelation rate. Faster gelation rate means shorter gelation time.

In one or more embodiments, the gelling system may have a gelation time that is of 2 days or more. For example, the gelant may have a gelation time that is of a range having a lower limit of any of 1, 1.5, 2, 2.5, 3, 4, and 5 days and an upper limit of any of 7, 10, 15 days, or even longer, where any lower limit can be used in combination with any mathematically-compatible upper limit. Faster gelation rate means shorter gelation time. In this disclosure, gelation time is evaluated by bottle test method. The flowability variation with time is visually observed to assess when the gelant starts to form gel.

In one or more embodiments, the gelant may, after gelation and as determined according to Sydansk, have a gel strength of D or more, of E or more, of F or more, or of G or more. Gelation times may be evaluated by a few different quantitative methods, including viscosity measurement, and viscoelastic property measurement (measuring elastic modulus and viscous modulus).

In one or more embodiments, the gelant may have a viscosity at reservoir temperature (for example, 80° C.) that is of the range of about 1 to 100 cP. For example, the gelant may have a viscosity at 80° C. that is of an amount of a range having a lower limit of any of 1, 2, 3, 4, 5, 6, 7, 8, 10, and 12 cP and an upper limit of any of 10, 20, 50, and 100 cP, where any lower limit can be used in combination with any mathematically-compatible upper limit. In some embodiments, the gelants may have a viscosity at 80° C. of 20 cP or less, 15 cP or less, or 10 cP or less. Viscosity correlates with injectivity. Lower fluid viscosity indicates that the fluid can be more easily injected into the reservoir formation. Viscosity is also a parameter that can be easily obtained in the laboratory.

In one or more embodiments, the gel may have a viscosity after gelation, as measured at 80° C., that is of the range of about 1,000 to 500,000 cP. For example, the gel may have a viscosity after gelation, as measured at 80° C., that is of an amount of a range having a lower limit of any of 2,000, 5,000, and 10,000 cP and an upper limit of any of 30,000 50,000, 100,000 and 500,000 cP, where any lower limit can be used in combination with any mathematically-compatible upper limit. In some embodiments, the gel may have a viscosity after gelation, as measured at 80° C., of 2,000 cP or more, 3,000 cP or more, 4,000 cP or more, or 6,000 cP or more. Viscosity is a parameter that may be indicative of the gel strength. Another quantitative indicator of gel strength is the elastic modulus G′. Gels are viscoelastic materials, exhibiting properties between elastic solids and viscous liquids. A common method to characterize the viscoelastic property is to measure the stresses while applying a sinusoidally oscillating shear strain. The stress wave may be separated into an elastic component and a viscous component. The elastic modulus, G′, is defined as the ratio of the elastic component to the maximum strain applied.

In one or more embodiments, the gel may have a ratio of viscosity after gelation to viscosity before gelation, as measured at 80° C., that is of the range of about 1,000:1 to 500,000:1. For example, the gels may have a ratio of viscosity after gelation to viscosity before gelation, as measured at 80° C., that is of the range having a lower limit of any of 1,000:1, 2,000:1,5,000:1, and 10,000:1 to an upper limit of any of 10,000:1, 50,000:1, 100,000:1 and 500,000:1, where any lower limit can be used in combination with any mathematically-compatible upper limit.

In one or more embodiments, the gel may have a pH that is neutral or acidic. For example, the gel may have a pH of a range having a lower limit of any of 2, 3, 4, 4.5, 5, 5.5, and 6, and an upper limit of any of 3, 4, 4.5, 5, 5.5, 6, 6.5, and 7, where any lower limit can be used in combination with any mathematically-compatible upper limit. In some embodiments, the gel may have a pH of 7 or less, of 6 or less, of 5 or less, of 4 or less, or of 3 or less.

In one or more embodiments, the gel may have a density that is greater than 0.90 g/cm³. For example, the gel may have a density that is of an amount of a range having a lower limit of any of 0.90, 0.95, 1.00, 1.05, 1.10, 1.15, and 1.20 g/cm³ and an upper limit of any of 1.00, 1.05, 1.10, 1.15, 1.20, 1.25, and 1.30 g/cm³, where any lower limit can be used in combination with any mathematically-compatible upper limit.

Oxidizers may be injected to remove the gel. Examples of oxidizers for gel cleaning include hydrogen peroxide, sodium hypochlorite of bleach, and ammonium peroxide.

### EXAMPLES

The following examples are merely illustrative and should not be interpreted as limiting the scope of the present disclosure.

Three gelants were prepared. All of the fluids contained a sulfonated polyacrylamide polymer (AN125), having a molecular weight of 8 million Daltons and a sulfonation degree of 25%, in an amount of 5,000 ppmw. The fluids contained both hexamethylenetetramine (HMTA) and hydroquinone (HQ) as crosslinking agents. The concentrations of the two crosslinkers were varied, though the ratio of HMTA to HQ was kept as 2:1. Example 1 contained 2,000 ppmw HMTA and 1,000 ppmw HQ, Example 2 contained 1,500 ppmw HMTA and 750 ppmw HQ, and Example 3 contained 1,000 ppmw HMTA and 500 ppmw HQ. The fluids contained a synthetic brine (57,612 mg/L total dissolved solids (TDS)). The detailed composition of the synthetic brine is shown in Table 1.

TABLE 1
Synthetic Brine Composition

| Salt | Content (mg/L) |
|---|---|
| NaCl, | 41,041 |
| CaCl₂•2H₂O | 2,384 |
| MgCl₂•6H₂O | 17,645 |
| Na₂SO₄ | 6,343 |
| NaHCO₃ | 165 |

One portion of each example was directly put to a 95° C. oven for aging. A second portion of each example was first preheated in a 120° C. oven for 3.0 h. After preheating, the sample was then also put to the 95° C. oven for aging. The flowability of the gelling samples was periodically observed by slightly tilting and inverting the bottle to evaluate gel strength at varied aging times. The gelation rate and gel strength were evaluated by the criterion of Sydansk, as discussed previously, and the results are shown in Table 2.

TABLE 2
Gel strength of bottle tests

| | Example 1 | | Example 2 | | Example 3 | |
|---|---|---|---|---|---|---|
| Time | no pre- | pre- | no pre- | pre- | no pre- | pre- |
| (days) | heating | heated | heating | heated | heating | heated |
| 1 | A | C | A | A | A | A |
| 2 | C | E | B | B/C | A/B | B |
| 3 | C/D | E/F | B | E | A/B | B/C |
| 4 | D | G | B/C | E | A/B | C |
| 5 | D | G | B/C | F | A/B | E |
| 7 | D | H | B/C | G | A/B | E |
| 9 | D | H | B/C | H | A/B | E |
| 11 | D | I/J | C | H | A/B | E/F |
| 14 | D | I/J | C | I/J | A/B | E/F |
| 20 | D | I/J | C | I/J | A/B | E/F |

The results show that, in the absence of preheating, all of these gelling systems cannot form a strong gel (of E or higher). As such, higher concentrations of the polymer and crosslinking agent would be necessary to form a strong gel at this temperature. However, with high-temperature preheating, the investigated gelants can form a strong gel after only 2 to 5 days, depending on the polymer and crosslinking agent concentrations. The strong gel was generated faster when using higher cros slinking agent concentrations. Accordingly, if longer gelation time is needed, lower crosslinking agent concentrations can be used.

Although the preceding description has been described herein with reference to particular means, materials and embodiments, it is not intended to be limited to the particulars disclosed herein; rather, it extends to all functionally equivalent structures, methods and uses, such as are within the scope of the appended claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112(f) for any limitations of any of the claims herein, except for those in which the claim expressly uses the words ‘means for’ together with an associated function.

1. A method for treating a hydrocarbon-containing formation, comprising:
preheating a gelant that contains a crosslinkable polymer, one or more crosslinking agents, and an aqueous fluid; and
injecting the gelant into the formation, wherein the gelant forms a gel in the formation
wherein the crosslinkable polymer is selected from the group consisting of a polyacrylamide; copolymer of acrylamide and acrylate; copolymer of acrylamide tertiary butyl sulfonate (ATBS) and acrylamides; copolymer of acrylamide, acrylic acid and ATBS; carboxymethyl cellulose (CMC); carboxymethylhydroxyethyl cellulose (CMHEC); xanthan gum; and combinations thereof.

2. The method of claim 1, wherein the gelant contains the crosslinkable polymer in an amount of 10,000 ppmw or less.

3. The method of claim 1, wherein the gelant contains the crosslinking agents in a total amount of 10,00 ppmw or less.

4. The method of claim 1, wherein the gelant is free of a chemical retardation agent.

5. The method of claim 1, wherein the preheating is performed at a temperature that is 10° C. or higher than the temperature of the hydrocarbon-containing formation.

6. The method of claim 1, wherein the preheating is performed for a duration of one hour or more.

7. The method of claim 1, wherein the gelant only forms a gel two days or more after the injection.

8. The method of claim 1, wherein the gelant has a viscosity of the range of about 1 to 100 cP.

9. The method of claim 1, wherein the gel has a viscosity of the range of about 1,000 to 500,000 cP.

10. The method of claim 1, wherein the hydrocarbon-containing formation comprises a zone of high permeability and a zone of low permeability.

11. The method of claim 10, wherein the gel is formed in the zone of high permeability.

12. A method for enhanced oil recovery, comprising:
preheating a gelant that contains a crosslinkable polymer, one or more crosslinking agents, and an aqueous fluid;
injecting the gelant into a high permeability zone of a hydrocarbon-containing formation, wherein the gelant forms a gel; and
stimulating a flow of hydrocarbons from a low permeability zone of the hydrocarbon-containing formation,
wherein the crosslinkable polymer is selected from the group consisting of a polyacrylamide; copolymer of acrylamide and acrylate; copolymer of acrylamide tertiary butyl sulfonate (ATBS) and acrylamides; copolymer of acrylamide, acrylic acid and ATBS; carboxymethyl cellulose (CMC); carboxymethylhydroxyethyl cellulose (CMHEC); xanthan gum; and combinations thereof.

13. The method of claim 12, wherein the gelant contains the crosslinkable polymer in an amount of 10,000 ppmw or less.

14. The method of claim 12, wherein the gelant contains the crosslinking agents in a total amount of 10,00 ppmw or less.

15. The method of claim 12, wherein the gelant is free of a chemical retardation agent.

16. The method of claim 12, wherein the preheating is performed at a temperature that is 10° C. or higher than the temperature of the hydrocarbon-containing formation.

17. The method of claim 12, wherein the preheating is performed for a duration of one hour or more.

18. The method of claim 12, wherein the gelant only forms a gel two days or more after the injection.

19. The method of claim 12, wherein the gelant has a viscosity of the range of about 1 to 100 cP.

20. The method of claim 12, wherein the gel has a viscosity of the range of about 1,000 to 500,000 cP.
